(19) United States
(12) Patent Application Publication
(10) Pub. No.: US 2005/0208183 A1
(43) Pub. Date: Sep. 22, 2005

(54) Method of and apparatus for making ethiopian bread

(76) Inventor: Emru Y. Desalegn, Garland, TX (US)

Correspondence Address: Michael A. O'Neil;Michael A. O'Neil, P.C., 5949 Sherry Lane, Suite 820, Dallas, TX, 75225, US

(21) Appl. No.: 11/079,568

(22) Filed: Mar. 14, 2005

Related U.S. Application Data
(60) Provisional application No. 60/553,387, filed on Mar. 16, 2004.

(51) Int. Cl. A23G 3/00

(52) U.S. Cl. 426/94

(57) ABSTRACT

An automated process for making Ethiopian bread comprises discharge of Ethiopian bread batter at spaced apart intervals along a continuously moving conveyor. The batter is spread into a predetermined configuration and then transported by the continuously moving conveyor through an oven wherein the Ethiopian bread is baked. Following baking the bread is transported through a cooling zone by the continuously moving conveyor, after which the bread is packaged and distributed.

### CLAIM OF PRIORITY

This application claims priority of prior provisional Application Ser. No. 60/553,387 filed Mar. 16, 2004.

### TECHNICAL FIELD

This invention relates generally to bread making, and more particularly to an automated process for making Ethiopian bread.

### BACKGROUND AND SUMMARY OF THE INVENTION

Ethiopian bread, known in the Ethiopian language as injera, is a soft and porous flat bread that serves as a center piece for Ethiopian cuisine. Heretofore all Ethiopian bread has been hand made. Although hand made Ethiopian bread can be exquisite in taste and texture, the laborious and time consuming procedures which are required to making Ethiopian bread by hand result in low throughput rates. Thus, the need exists for an automated system for making Ethiopian bread.

The present invention comprises a method of and apparatus for making Ethiopian bread which overcomes the foregoing and other difficulties which have long since characterized the prior art. In accordance with the invention, Ethiopian bread batter is mixed in substantial quantities. The batter is discharged at spaced apart intervals along a moving conveyor and is thereafter spread into the desired shape. The conveyor then transports the spread, uncooked batter through an oven wherein the Ethiopian bread is fully baked. The conveyor then transports the baked Ethiopian bread through a cooling zone wherein the temperature of the bread is significantly reduced. The fully processed bread is removed from the discharge end of the conveyor for packaging and distribution.

### BRIEF DESCRIPTION OF THE DRAWINGS

A more complete understanding of the present invention may be had by reference to the following Detailed Description when taken in connection with the accompanying Drawings, wherein:

FIG. 1 is an end view of an apparatus for making Ethiopian bread comprising the present invention;

FIG. 2 is a side view of the apparatus of FIG. 1;

FIG. 3 is a view similar to FIG. 1 illustrating a second embodiment of the invention;

FIG. 4 is a side view of the embodiment of the invention shown in FIG. 3; and

FIG. 5 is an illustration of the method of the present invention.

### DETAILED DESCRIPTION

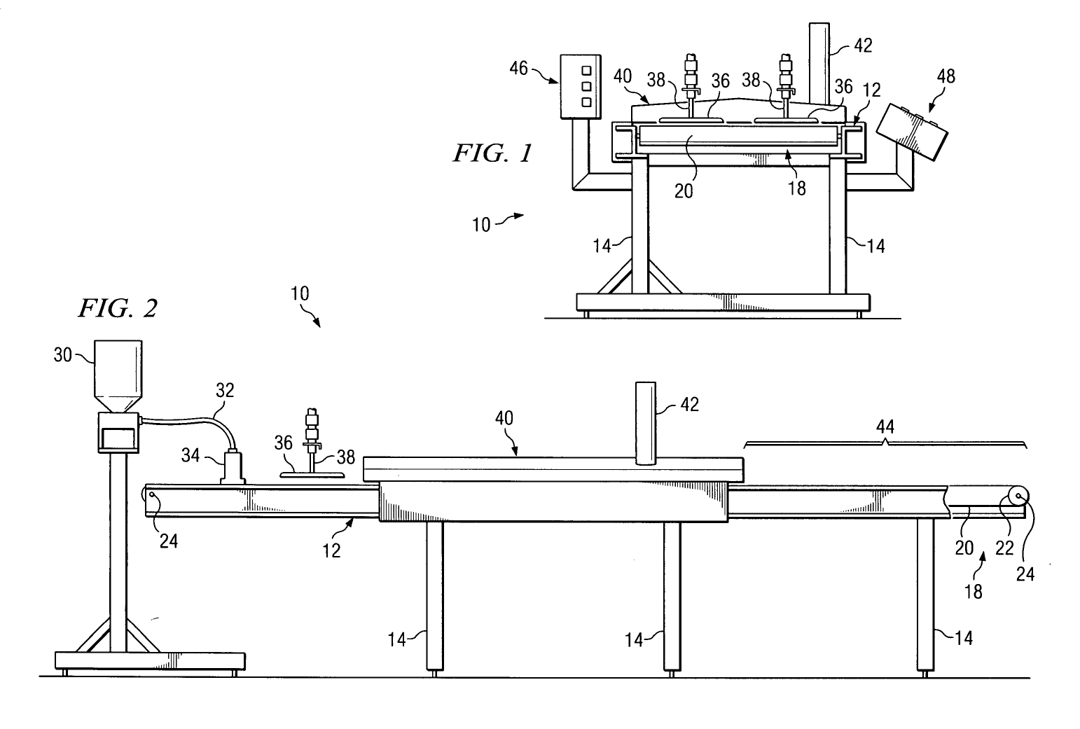

Referring now to the Drawings, and particularly to FIGS. 1 and 2 thereof, there is shown an Ethiopian bread making apparatus 10 comprising a first embodiment of the invention. The apparatus 10 includes a frame 12 which is supported on the underlying surface by a base 14. A conveyor 18 extends the entire length of the frame 12 and comprises a conveyor belt 20 which is trained around a pair of rollers 22. The rollers 22 are in turn supported by axles 24 located at the opposite ends of the frame 12. In the operation of the apparatus 10, the conveyor 18 operates continuously under the action of a suitable drive mechanism.

An Ethiopian bread batter reservoir 30 is located at one end of the frame 12 of the apparatus 10. A pump directs batter from the reservoir 30 through hoses 32 extending from the reservoir 30 to a pair of batter discharge devices 34. The batter discharge devices 34 includes a closure apparatus to prevent dripping of the batter. In the operation of the apparatus 10 the batter discharge devices 34 function to discharge predetermined quantities of Ethiopian bread batter at spaced apart intervals along the moving conveyor 18. As discharged the quantities of Ethiopian bread batter which are deposited onto the moving conveyor 18 have a relatively thick, relatively small diameter configuration.

Having been discharged from the batter discharge devices 34 the quantities of Ethiopian bread batter pass under a pair of spreader plates 36. The spreader plates 36 are normally positioned sufficiently above the moving conveyor 18 to allow the quantities of batter to pass freely thereunder. When individual quantities of Ethiopian bread batter are centered under the spreader plates 36, the spreader plates 36 are driven downwardly toward the conveyor 18 by pneumatic actuators 38. Downward movement of the spreader plates 36 flattens the quantities of Ethiopian bread batter into the relatively thin, relatively large diameter configuration which is characteristic of Ethiopian bread.

Having passed under the spreader plates 36, and having been flattened and shaped thereby, the quantities of Ethiopian bread batter are carried by the conveyor 18 through an oven 40. The oven 40 is of the type commonly referred to in the bakery machinery industry as a tunnel oven. The oven 40 may comprise a plurality of electrical heating units whereby the temperature within the oven 40 is accurately maintained. Alternatively, the oven 40 may be heated by the combustion of an appropriate fuel such as natural gas. The interior of the oven 40 is vented to the atmosphere through an exhaust stack 42.

After passing through the oven 40 the now baked Ethiopian bread enters a cooling zone 44. In the cooling zone 44 heat is dissipated from the baked Ethiopian bread into the atmosphere. At the end of the frame 12 remote from the batter reservoir 30 the now finished Ethiopian bread is removed from the conveyor 18 for packaging and distribution.

Referring specifically to FIG. 1, the apparatus 10 further includes a temperature control unit 46 which is supported on one side of the base 14 and which functions to control the baking temperature within the oven 40. A computer control unit 48 is mounted on the opposite side of the frame 14 and functions to control the speed of the conveyor 18 as well as the other operating perimeters of the apparatus 10.

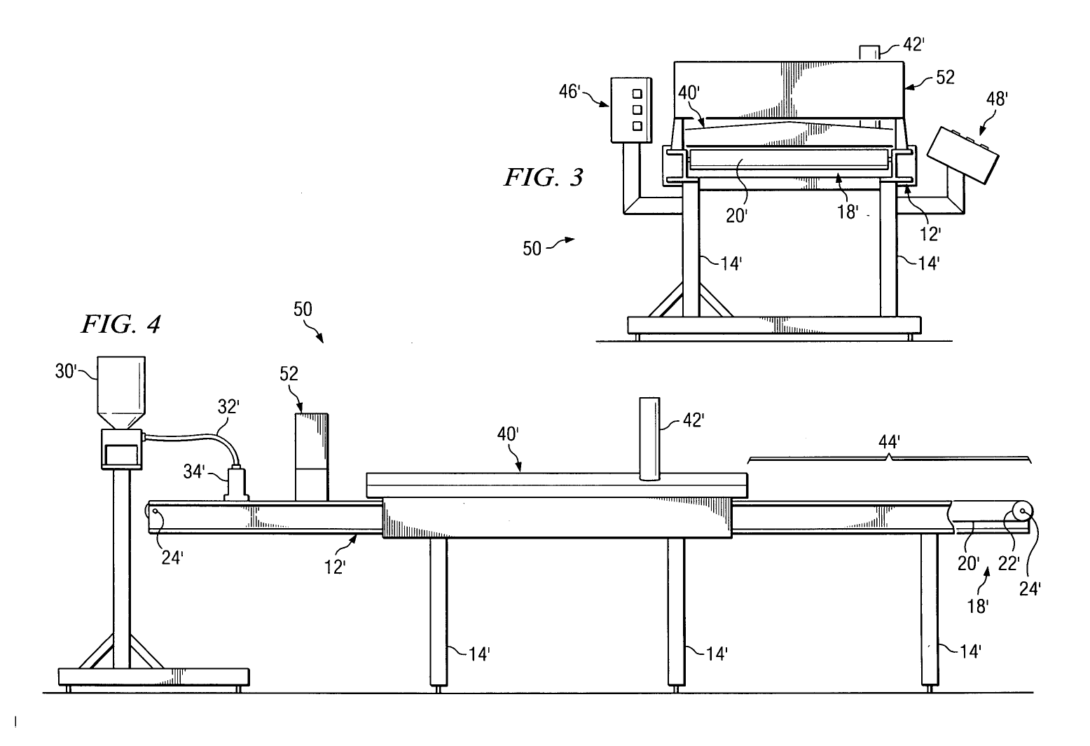

Referring to FIGS. 3 and 4 there is shown an Ethiopian bread making apparatus 50 comprising a second embodiment of the invention. The apparatus 50 includes numerous component parts which are substantially identical in construction and function to component parts of the Ethiopian bread making apparatus 10 shown in FIGS. 1 and 2 and described hereinabove in conjunction therewith. Such identical component parts are designated in FIGS. 3 and 4 with the same reference numerals utilized in the description of the Ethiopian bread making apparatus 10 but are differentiated therefrom by means of a prime (′) designation.

The Ethiopian bread making apparatus 50 differs from the Ethiopian bread making apparatus 10 in that in lieu of the spreader plates 36, the apparatus 50 employs a pneumatic device 52 to spread and shape the Ethiopian bread batter as discharged from the batter discharging devices 34′ into the relatively thin, relatively large diameter shapes which are characteristic of Ethiopian bread. The pneumatic device 52 comprises air discharge jets which operate continuously and which function to shape the Ethiopian bread batter as it passes through the pneumatic device 52 under the operation of the conveyor 18′.

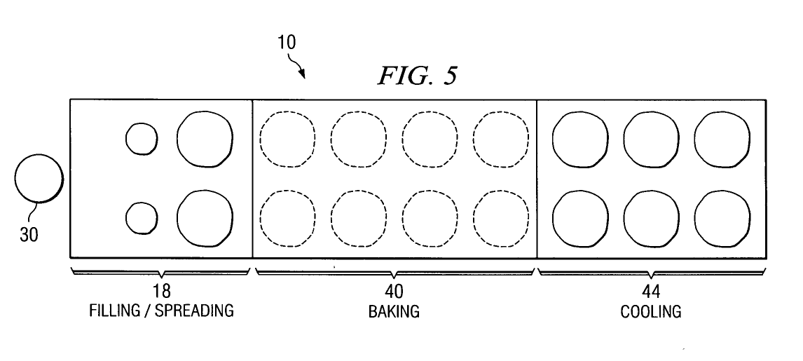

The method of the present invention as illustrated in FIG. 5. Ethiopian bread batter is received in a reservoir 30. The Ethiopian bread batter from the reservoir 30 is discharged at spaced apart intervals along a moving conveyor 18. As discharged the batter is in a relatively thick, relatively small diameter configuration. Immediately following discharge the batter is spread into a relatively thin, relatively large diameter configuration. Following spreading the batter is transported by the conveyor 18 through an oven 40 wherein the Ethiopian bread is baked. Thereafter the baked Ethiopian bread is transported through a cooling zone 44 wherein the temperature of the baked bread is substantially reduced. At the end of the cooling zone 44, the baked and cooled Ethiopian bread is removed from the conveyor 18 for packaging and distribution.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An apparatus for making Ethiopian bread comprising:
a reservoir for receiving Ethiopian bread batter;
a continuously moving conveyor;
means for discharging Ethiopian bread batter from the reservoir onto the continuously moving conveyor;
means for spreading the Ethiopian bread batter on the continuously moving conveyor following the deposit thereof onto the conveyor;
an oven for baking the spread Ethiopian bread batter during transportation thereof by the continuously moving conveyor;
means defining a cooling zone;
the continuously moving conveyor for transporting the baked Ethiopian bread through the cooling zone following baking thereof in the oven.

2. The apparatus for making Ethiopian bread according to claim 1 wherein the means for spreading the Ethiopian bread batter comprises at least one spreader plate for spreading the Ethiopian bread batter into a predetermined configuration during movement thereof under the action of the continuously moving conveyor.

3. The apparatus for making Ethiopian bread according to claim 1 wherein the means for spreading the Ethiopian bread batter comprises at least one air discharge nozzle for spreading the Ethiopian bread batter into a predetermined configuration during transportation thereof by the continuously moving conveyor.

4. The apparatus for making Ethiopian bread according to claim 1 further comprising means for controlling the temperature of the oven.

5. The apparatus for making Ethiopian bread according to claim 1 further comprising means for controlling the speed of the continuously moving conveyor.

6. The apparatus for making Ethiopian bread according to claim 1 wherein the means for discharging the Ethiopian bread batter onto the conveyor is a plurality of discharge devices which discharge the Ethiopian bread batter at spaced intervals along the conveyor.

7. The apparatus for making Ethiopian bread according to claim 1 wherein the oven is a tunnel oven.

8. An apparatus for making Ethiopian bread comprising:
a reservoir for receiving Ethiopian bread batter;
a continuously moving conveyor;
a plurality of discharge devices for discharging the Ethiopian bread batter from the reservoir onto the continuously moving conveyor at spaced intervals;
means for spreading the Ethiopian bread batter on the continuously moving conveyor following the deposit thereof onto the conveyor;
a tunnel oven for baking the spread Ethiopian bread batter during transportation thereof by the continuously moving conveyor;
means defining a cooling zone;
the continuously moving conveyor for transporting the baked Ethiopian bread through the cooling zone following baking thereof in the oven;
means for controlling the temperature of the oven; and
means for controlling the speed of the continuously moving conveyor.

9. The apparatus for making Ethiopian bread according to claim 8 wherein the means for spreading the Ethiopian bread batter comprises at least one spreader plate for spreading the Ethiopian bread batter into a predetermined configuration during movement thereof under the action of the continuously moving conveyor.

10. The apparatus for making Ethiopian bread according to claim 8 wherein the means for spreading the Ethiopian bread batter comprises at least one air discharge nozzle for spreading the Ethiopian bread batter into a predetermined configuration during transportation thereof by the continuously moving conveyor.

11. The method for making Ethiopian bread comprising the steps of:
providing a quantity of Ethiopian bread batter;
receiving the Ethiopian bread batter in a reservoir;
providing a continuously moving conveyor;
discharging predetermined quantities of the Ethiopian bread batter onto the continuously moving conveyor at spaced apart intervals there along;
spreading the received Ethiopian bread batter into a predetermined configuration during movement thereof by the continuously moving conveyor;
baking the spread Ethiopian bread batter during movement thereof by the continuously moving conveyor;
cooling the baked Ethiopian bread during movement thereof by the continuously moving conveyor; and
receiving the finished Ethiopian bread from the continuously moving conveyor.

12. The method for making Ethiopian bread according to claim 11 wherein the step of discharging predetermined quantities of the Ethiopian bread batter onto the moving conveyor is carried out by at least one spreader plate for spreading the Ethiopian bread batter into a predetermined configuration during movement thereof under the action of the continuously moving conveyor.

13. The method for making Ethiopian bread according to claim 11 wherein the step of discharging predetermined quantities of the Ethiopian bread batter onto the moving conveyor is carried out by at least one air discharge nozzle for spreading the Ethiopian bread batter into a predetermined configuration during transportation thereof by the continuously moving conveyor.
